(19) United States
(12) Patent Application Publication
(10) Pub. No.: US 2013/0122849 A1
(43) Pub. Date: May 16, 2013

(54) Fall-Responsive Emergency Device, System, and Method

(71) Applicants: Mary Doezema, Traverse City, MI (US); Joseph A. Thiel, Interlochen, MI (US)

(72) Inventors: Mary Doezema, Traverse City, MI (US); Joseph A. Thiel, Interlochen, MI (US)

(73) Assignee: J&M I.P. HOLDING COMPANY, LLC, Traverse City, MI (US)

(21) Appl. No.: 13/812,010

(22) PCT Filed: Jul. 29, 2010
(86) PCT No.: PCT/US10/43678

§ 371 Date: Jan. 24, 2013

(51) Int. Cl. H04W 4/22

(52) U.S. Cl. CPC H04W 4/22
USPC 455/404.1

(57) ABSTRACT

A device capable of being worn by a person includes a fall sensor responsive to the physical effect of a fall by a person wearing the device to generate a sensed-fall signal. A wireless transmitter can send a wireless alert signal in response to the sensed-fall signal without requiring participation by the person wearing the device. A base transmitter locatable on a premises where the device is to be worn can be enabled in response to the wireless alert signal to transmit a responder request to a remote responder. A two-way voice communicator separate from the wearable device can be located on the premises with the base transmitter. A remote responder can enable the two-way voice communicator for two-way voice communication with the person wearing the wearable device.

### TECHNICAL FIELD

The subject matter of the present application is in the field of wearable emergency devices, the devices having capability to alert others at distant locations of the existence of an emergency or a need for assistance experienced by the person wearing the device. These may sometimes also be referred to as “aging-in-place” or “caregiver assistance” devices.

### BACKGROUND ART

Wearable devices capable of transmitting “personal assistance needed” or emergency signals to remote friends, relatives, caregivers, and emergency personnel (hereafter “remote responders”) are generally known. These devices typically require conscious activation of an emergency alert transmitter to notify remote responders of the existence of a medical, personal or other emergency. For example, some devices effectively function as wearable, easy-to-use emergency phones; other devices send a simple alert signal in response to the press of a button or some other deliberate signal activation by the person wearing the device. Persons with potential need for such devices include older adults, individuals living alone, persons with disabilities or chronic diseases, infants in danger of being shaken, and individuals working in high places such as rooftops, ladders or scaffolds

Prior devices require the person wearing the device to be conscious and able to make a call or activate a signal, to be free of Alzheimer's, Parkinson's or other related diseases affecting the nervous system so they can reach the device, and to generally be in awareness of the emergency situation. Prior devices may also rely on voice communication to indicate the nature of the emergency, which can be limiting in some circumstances. Prior devices may also rely on remote call centers to receive and process calls.

### BRIEF SUMMARY

We have invented a wearable, hands-free emergency alert device and system that responds automatically to a measurable physical effect of a slip, trip, fall or similar accident or potentially injurious event (hereafter “fall”) by the wearer to send an alert signal to a remote responder. Measurable physical effects include, but are not limited to, movement, vibration, and/or sound.

The wearable device incorporates a fall-sensor capable of recognizing the physical effect of a fall or similar abnormal motion (as distinguished from non-emergency movements and vibrations), and a wireless transmitter that sends a wireless alert signal in response to a sensed fall. The wearable fall-responsive device may optionally include a manual alert to signal non-fall emergencies.

The system includes the wearable fall-responsive device and an on-premises transmitter (“base transmitter”) for responding to the alert signal by sending a request for a remote responder (someone located off-premises). In a further form the system includes one or more local wireless two-way voice communicators that are located on-premises in signal communication with the base transmitter, and in stationary locations within voice distance of possible fall locations; that are separate from the wearable device; and that can be enabled by a remote responder for two-way voice communication with a fallen person after the responder receives the request from the base transmitter. In a further form, the on-premises two-way voice communicator receives the alert signal from the wearable fall-responsive device and enables the base station transmitter to request a remote responder.

In a further aspect, some or all of the two-way voice communication enabled between the local communicator and the fallen person is independent of the wearable device; i.e., although the wearable device might include a voice transmitter and/or receiver to boost the ability of a fallen person to communicate by voice with the local communicator, the local communicator is able to provide direct voice-to-voice communication with the fallen person.

In one form the wearable device senses a fall with a vibration sensor. In another form the wearable device senses a fall with an accelerometer.

The invention further comprises a method for responding to a monitored person's fall, in which a fall-sensing device is worn, a fall alert signal is delivered wirelessly to enable a base transmitter, the base transmitter is activated to send a responder request to a remote responder, and, if available, the remote responder enables two-way voice communication with the fallen wearer via an on-premises two-way communication device separate from the wearable device. In a further form, the alert signal is received by the on-premises two-way communication device which then enables the base station transmitter.

In a further form, the on-premises two-way communication device is a fixture on the premises.

These and other features and advantages of the invention will become apparent from the detailed description below, in light of the accompanying drawings.

### BRIEF DESCRIPTION OF THE DRAWINGS

FIG. 1 is a perspective view of a wearable device capable of sending a fall-responsive alert signal.

FIG. 1A is an exploded assembly view of the device of FIG. 1.

FIG. 2 is a schematic view of a system including the wearable device of FIG. 1, on a premises where a person wearing the wearable device might fall.

FIG. 3 is a schematic representation of a fall event in the system-equipped premises of FIG. 2, and of a chain of signaling and communication between a fallen person and a remote responder.

FIG. 4 is a functional flowchart representation of a method using the system of FIG. 2.

FIG. 5 is a perspective view of a local two-way voice communicator from FIGS. 2-4, exploded away from a wall socket where it is installed.

### DETAILED DESCRIPTION

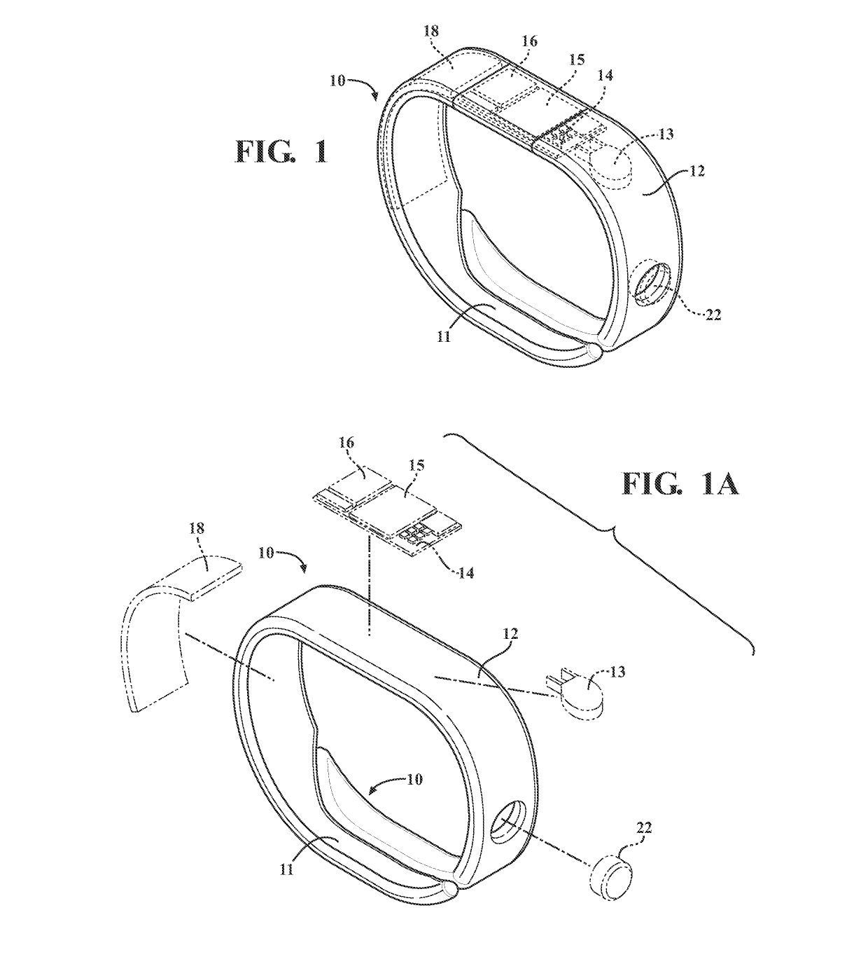

Referring first to FIG. 1, a wearable device 10 is shown in exemplary form in order to teach how to make and use the claimed subject matter. Wearable device 10 is illustrated in a preferred form as a bracelet 12 worn on the wrist, although it may take different forms provided the device is “wearable” or “worn”, i.e. can be carried or worn and retained on a person without conscious effort once donned or applied. Alternate examples of wearable device forms include, but are not limited to, necklaces, rings, pin-on items, belts, watches, belt attachments, bands around the chest, items capable of being carried in a pocket, and articles of clothing.

Bracelet 12 may be made from different materials, in the illustrated form being a combination of metal and polymer materials, and may be adjustable as illustrated at 11. Other materials and combinations of materials, including precious metals and gems so that the bracelet functions as jewelry or the addition of texting screens for reminders and cueing, are also possible. In the illustrated example, bracelet 12 includes a controller device 14, in the illustrated example a chipset housing incorporating one or more chips or integrated circuits; a fall sensor 16 embedded in or otherwise secured to the body of bracelet 12; a battery 18; and wiring 20 contained or embedded in the body of the bracelet to interconnect chipset 14, fall sensor 16, and battery 18 with respect to electrical power needs and signal communication. Chipset 14 may include, a wireless transmitter function, or a separate wireless transmitter 15 may be incorporated in the bracelet and connected with wiring 20 to chipset 14, sensor 16, and battery 18 as needed. Chipset 14 may also include GPS and/or USB functionality and connections. While the functional components of bracelet 12 are illustrated as being embedded in or otherwise integrated into the bracelet, other methods for securing or attaching some or all of the components should be possible, including external attachments and making the body of bracelet 12 hollow to permit internal mounting of components.

Suitable devices for carrying out the functions of chipset 14, transmitter 15, and sensor 16 are commercially available and known. Chipset 14, for example, may be a CSR BlueCore 5 chipset or Qualcomm/Texas Instruments equivalent. Transmitter 15 may be a standard use 915 mHz, 2.4 GHz, or 6.0 Ghz transmitter of any type commonly used in wireless phone applications. Sensor 16 may be an acceleration sensor or a vibration sensor, such as a VTT or TI standard chip base accelerometer. These examples are currently preferred, but it should be understood that alternatives exist. Also, chipset firmware 14 can be suitably programmed or encoded to coordinate the interaction of fall sensor 16 and transmitter 15. While a chipset is illustrated as the preferred means for effecting and controlling the functionality of bracelet 12, alternatives and equivalents including but not limited to other types of controller, software, hardware, and/or firmware may be suitable.

Fall sensor 16 is responsive to a physical effect of a fall, whether measured by vibration, shock, acceleration, sound, a combination of the foregoing effects, or some other measurable physical effect of a fall as determined to be desirable. These may vary according to the intended use, the intended location, or the expected risk to an end-user wearing the bracelet. In the illustrated example it is assumed that fall sensor 16 is a vibration sensor of the chip-based accelerometer type. Also, more than one type of fall sensor 16 may be incorporated in bracelet 12 to sense more than one physical effect of a fall; for example, a vibration sensor and an acceleration sensor may be used in parallel to sense a wider range of physical effects that would indicate that a fall has taken place.

When someone wearing bracelet 12 falls, fall sensor 16 is activated to generate a sensed-fall signal that is transmitted by wiring 20 to chipset 14 and/or transmitter 15. Chipset 14 responds to the sensed fall signal to activate transmitter 15, which sends a wireless alert signal to an appropriate receiver at a distance from the person wearing bracelet 12. The person wearing the device need not consciously activate the bracelet to generate the wireless alert signal, and need not be conscious for the alert signal to be sent—bracelet 12 responds to the sensed physical effect of the fall event without conscious input by the user.

Illustrated bracelet 12 also has a manual alert actuator 22, in the example shown as a recessed button on the inside (or alternately outside) surface of bracelet 12. This can be a button or switch of any type. In the illustrated example, actuator 22 is imbedded in the bracelet housing to maintain a smooth surface contour. Actuator 22 is preferably exposed on both the inside and outside of the bracelet, so that it must be located and squeezed between the thumb and pointer finger of the user from both sides, in order to prevent unintentional activation by bumping or normal activity. Button 22 can be intentionally activated by a person wearing the device to send an alert signal for non-fall events or sudden illnesses, or as a backup to the automatic generation of an alert signal by the fall sensor 16, with compression between a finger and thumb. Other types of manual alert actuators are possible, including but not limited to voice-activated actuators responsive to certain key words.

Bracelet 12 may also be provided with a vibratory output alert 13, in the illustrated example a 3-vibe alert triggered by the activation of button 22 to send a vibratory warning to the user that a wireless alert notice is about to be sent from the bracelet to the base station. This gives the wearer an opportunity to cancel the alert signal, for example with another press of button 22, in case the activation was accidental.

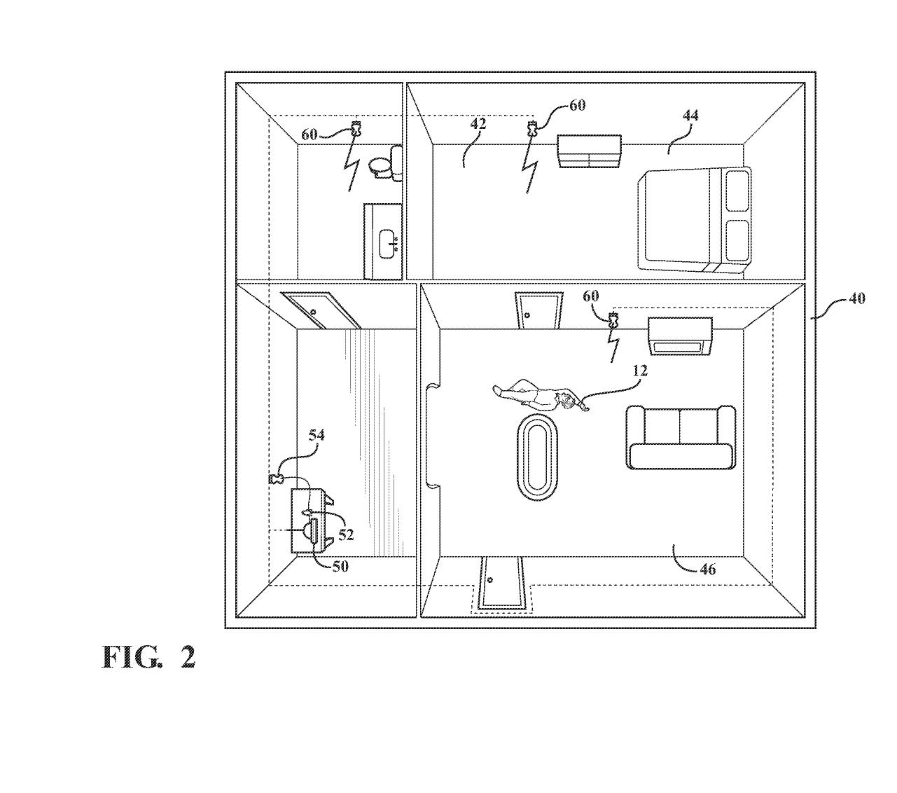

Referring next to FIG. 2, a premises 40 such as a house is equipped with a system that incorporates bracelet 12 and that responds to the wireless alert signal produced by bracelet 12 during a fall event. Premises 40 has one or more likely or possible fall locations, for example a bathroom 42, a bedroom 44, and a living room 46. A base transmitter 50 is located on-premises and is connected to means 52 for communicating with one or more remote responders who are off-premises. In the illustrated example, base transmitter 50 is a device that receives an RF signal from an associated device, in this case bracelet 12. Once activated, the internal programming of base transmitter 50 follows a step by step process to call one or preferably more (e.g., five) pre-determined and programmed telephone numbers, or sends programmed text messages or otherwise makes a contact attempt with a remote responder using any known and conveniently used form of communication. Once the signal is received by a remote responder, he or she manually enters a form of pre-programmed coded message, for example either a number or letter combination (similar to remotely checking your voice mail). Once the proper code is entered, the base transmitter 50 opens communication between the fallen person and the responder. If no code is entered the base unit 50 can be programmed to call a call center or emergency services. In the illustrated example, means 52 is a telephone communicating with the outside world by landline 54. Other possibilities for the remote communication means 52 include (but are not limited to) cable modems, satellite dishes, mobile phones, or long-range RF transmitters. The connection between base transmitter 50 and the remote communication means 52 may be wireless or wired.

If a person wearing bracelet 12 should fall on premises 40, bracelet 12 sends a wireless alert signal that is received by the base transmitter 50, or that is relayed in original or modified signal form by an intermediate device to base transmitter 50. Base transmitter 50 is then enabled to request the intervention or assistance of a remote responder by sending a predetermined remote responder request via phone 52. The remote responder request can be any signal or message capable of being transmitted off-premises and being recognized by a remote responder (human or automated), for example a pre-recorded voice message, an email or text, a distinctive tone, or a machine-readable alarm signal. In situations and on premises where a remote responder may be within hearing of the premises 40, one possible remote responder request could be a tactile alarm that is audible or visible from off-premises.

It will also be understood that “on-premises” and “off-premises” could be locations included in a single dwelling or building not normally in communication with each other, for example two different apartments in an apartment building or two different floors in a skilled nursing or re-habilitation facility, dementia care or assisted living facility or senior residential community or continuum of care facility, a hospital or a medical clinic, where a remote responder is located far enough from the person wearing bracelet 12 that he or she would not be likely to hear a fall event, and would need to be notified via base station 50 of the event.

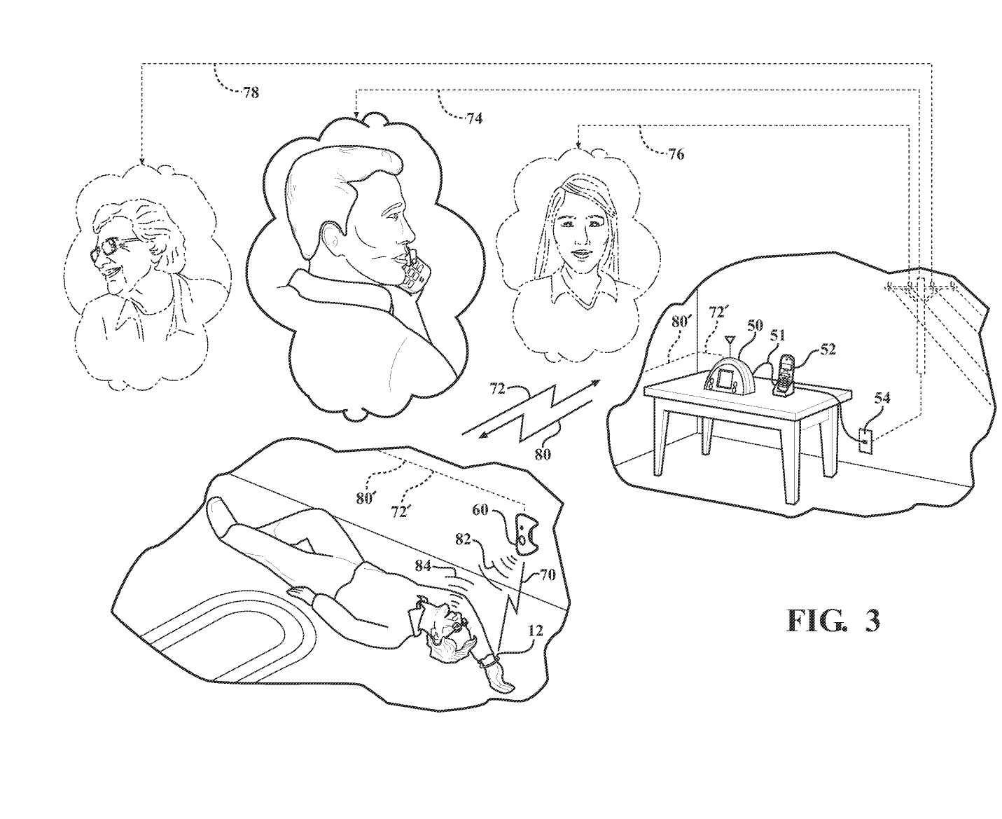

Referring next to FIG. 3, the system also includes one or more local communicators 60 mounted in various stationary locations on the premises 40 within voice communication distance of possible fall locations. Communicators 60 are stationary in use, although they need not be permanently fixed in place and could be moved to different locations for optimum voice communication based on testing and/or as needed on the premises given anticipated fall locations. Examples of stationary locations include but are not limited to direct plug-in connection in electrical outlets, wall-mounted locations, furniture-mounted locations, and attachment to or incorporation into appliances.

In the illustrated example of FIG. 3, a person wearing bracelet 12 has fallen in a room of the house 40 different than the room in which base station transmitter 50 is located. Bracelet 12 senses the fall and sends a wireless alert signal 70 to two-way local voice communicator unit 60 mounted in a wall outlet in the room where the fall occurred. Local communicator 60 in turn either relays the fall alert signal, or sends a fall notification signal (hereafter both referred to as “notification” signal) to base station 50, via wireless signal 72 and/or wire-transmitted signal 72′. Base station 50 is enabled to generate a responder request signal, which is transmitted through connection 51 (wired or wireless) to remote communication means 52 (a telephone or modem) which sends the request off-premises via communication link 54 (landline). The remote responder request is sent to at least one predetermined responder R1, and preferably to additional responders R2, R3, . . . , over respective communication links 74, 76, and 78. For example, the phone/modem 52 dials five pre-programmed telephone numbers in preset order. The remote responders' telephone or other contact connections (email, fax, mobile phone, text) are programmed into the base station transmitter 50 or the remote communication means 52.

In the illustrated example of FIG. 3, one remote responder R1 is available and gives a response to the request for assistance, while responders R2 and R3 are unavailable and do not. Responder R1 is shown having received the request by telephone call, for example a prerecorded voice message such as “John, it's me, I need help. Please call me back at telephone number xxx-xxx-xxxx.” When responder R1 acknowledges that the call has been accepted by an authorized responder, for example by entering a numeric code via the phone keys to notify the system that the call has been accepted by an authorized responder, and/or more directly by placing a return phone call, via link 74, 54, 52, and 51, base station 50 activates at least the nearest, and optionally all, of the local communicators 60 on the premises via wireless and/or wired signals 80, 80′. The fallen person wearing bracelet 12 and responder R1 can then communicate directly by voice through the nearest local communicator 60, even if the fallen person is immobile, as represented at 82, 84. For premises where there might be communication-interfering noise in rooms other than where a fall occurred, it would be possible to choose and program a protocol for activating only the local communicator 60 nearest to the fallen person, for example by sensing the fall signal strength or the distance of bracelet 12 from each of the local communicators 60 on the premises 40.

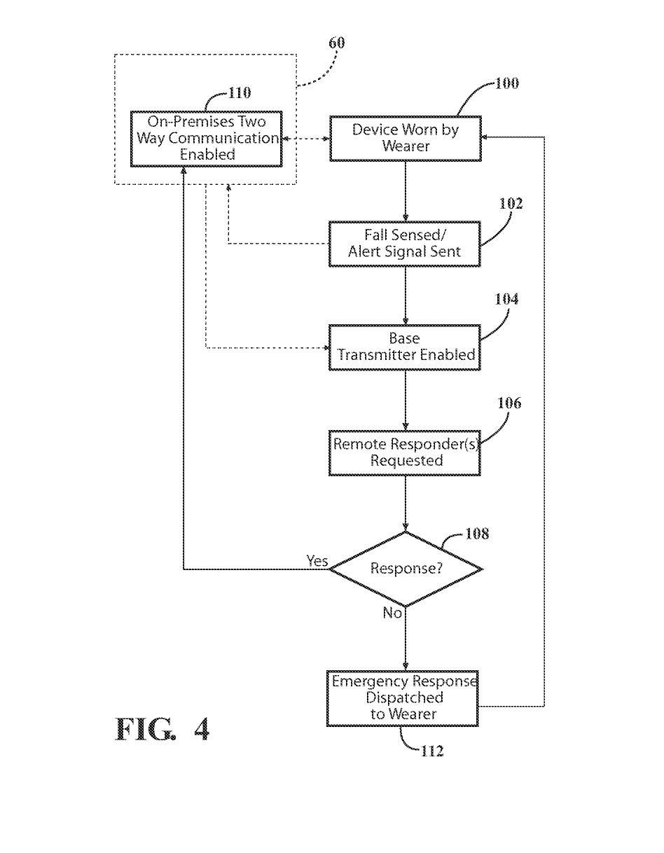

FIG. 4 schematically illustrates a method of sensing a fall and bringing a remote responder into communication with a fallen person wearing bracelet 12. At 100 a person at risk of a fall wears the fall-sensing device, for example bracelet 12. At 102 a fall is sensed (after the person has fallen, of course) and a wireless alert signal is sent to the appropriate receiver, whether directly to a base station transmitter at 104 or indirectly via a local communicator or other intermediate device at 110. At 104 the base station transmitter is enabled to make a responder request, which is sent off-premises at 106 to one or more remote responders. At 108 the one or more remote responders either respond or they do not. If a responder does respond, two-way voice communication is enabled on-premises at 110 directly with the fallen person still wearing the device at 100. If no responder responds, a less personal emergency responder unit such as police, fire department, or ambulance service is requested by the base station transmitter, for example with a phone call to 911 and a pre-recorded message for help along with address information and the likely nature of the emergency (a fall). In the event that only a 911 type emergency unit is requested by the system, the local on-premises communicators 60 are also activated for two-way voice communication, but in this instance between the fallen person and the 911 operator and/or personnel en route.

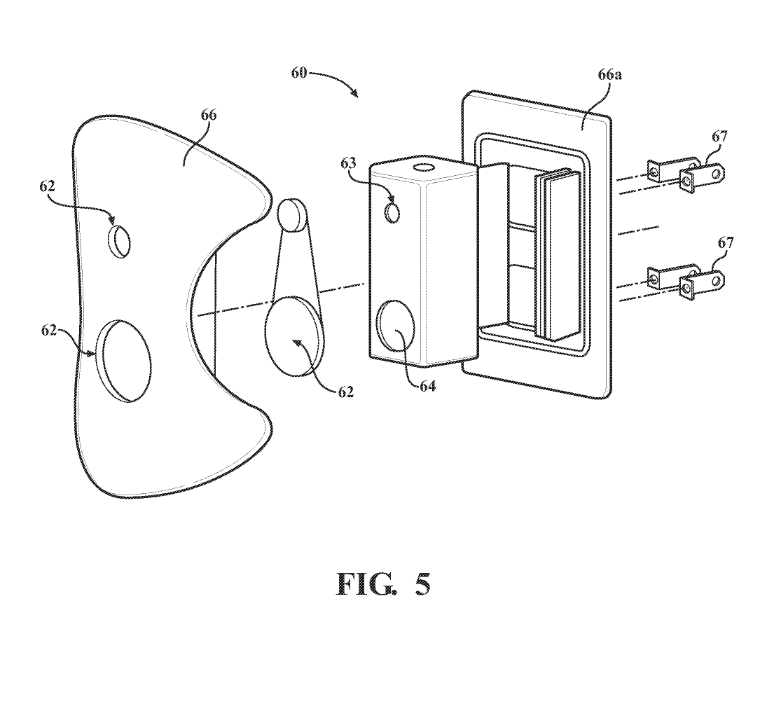

FIG. 5 shows details of local communicator 60, in the illustrated example a plug-in two-way voice type similar to an intercom unit. Communicator 60 is illustrated with a main housing, for example molded from a durable polymer material, with a front face having speaker slots 62, and hidden receiver speaker 63, a transmitter speaker 64, and AC outlet prongs 67 capable of being plugged into a standard AC electrical outlet in a wall or other convenient location. An optional decorative or protective cover 66 can be used over communicator 60. Options such as night-lights, ambient lighting, battery backup power, status indicator lights, flashing alert lights for hearing-impaired caregiver responders who are located on premises, and others can be incorporated into or combined with communicator 60. In the illustrated example, communicator 60 uses a 2.8 Ghz surround sound speaker-and-microphone system of known and commercially available type to provide clear two-way voice communication and, if necessary, clear listening by an on-premises caregiver responder. Communicators 60 can also provide the ability to communicate with emergency personnel on-site when enabled.

In a further and preferred form, local communicator 60 is designed to be more permanently attached to a wall outlet in replacement of the normal outlet cover plate 66a, for example with screws fitting the outlet mounting box, so that communicator can be considered a “fixture” for insurance purposes and so that children, cleaning people, etc. are not likely to temporarily remove it from the wall and then forget to put it back. Securing the communicators 60 as “fixtures” may also provide additional value to the home as a system when the home is sold.

Bracelet 12 could also be used by mothers with infants in danger of being shaken by childcare providers or inexperienced babysitters. The set point or sensitivity of the fall sensor, for example an accelerometer, could be adjusted to detect a repeated, violent shaking and prompt an alert signal when worn on the ankle of an infant.

In the preceding description, various aspects and examples and configurations of making and using the invention as defined by the claimed subject matter have been described, for purposes of explanation, to provide a thorough understanding of claimed subject matter, and to enable those skilled in the art to make and use claimed subject matter. However, these are merely example illustrations and descriptions of inventive concepts and other illustrations may apply as well, and the scope of claimed subject matter is not limited in these respects. It should be apparent to one skilled in the art having the benefit of this disclosure that claimed subject matter may be practiced without being limited to the specific details of the disclosure. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of invention as reflected by the preceding disclosure. It should further be understood that to the extent the term “invention” is used in the written specification, it is not to be construed as a limiting term as to number or type of claimed or disclosed inventions or the scope of any such invention, and does not exclude discoveries or designs; rather, it is a term which has long been conveniently and widely used to describe new and useful improvements in technology.

What is claimed is:

1. A system to send a wireless alert signal in response to a fall by a person, characterized by:
a device capable of being worn by a person, the device comprising a fall sensor responsive to a physical effect of a fall by a person wearing the device to generate a sensed-fall signal, the device further comprising a wireless transmitter capable of sending a wireless alert signal in response to the sensed-fall signal from the fall sensor without requiring participation of a person wearing the device;
a base transmitter adapted to be located on a premises where the device is to be worn, the base transmitter capable of being enabled in response to the wireless alert signal to transmit a responder request to a remote responder; and
a two-way voice communicator separate from the wearable device, the two-way voice communicator adapted to be located on a premises with the base transmitter, the two-way voice communicator capable of being enabled by a remote responder for independent two-way voice communication between a remote responder and a person wearing the wearable device.

2. The wearable device of claim 1, the fall sensor comprises a vibration sensor.

3. The wearable device of claim 1, the fall sensor comprises an acceleration sensor.

4. The wearable device of claim 1, the wearable device comprises a bracelet.

5. The system of claim 1, the two-way voice communicator further comprising a signal receiver for receiving the wireless alert signal from the wearable device and a signal transmitter for transmitting a fall notification signal to the base transmitter, and the base transmitter is capable of responding to the fall notification signal by transmitting a responder request to a remote responder.

6. On a premises where a person may fall, a safety system characterized by:
a device capable of being worn by a person, the device comprising a fall sensor responsive to a physical effect of a fall by a person wearing the device to generate a sensed-fall signal, the device further comprising a wireless transmitter capable of sending a wireless alert signal in response to the sensed-fall signal from the fall sensor without requiring participation of a person wearing the device;
a base transmitter located on the premises, the base transmitter capable of being enabled in response to the wireless alert signal to transmit a responder request to a remote responder; and
a two-way voice communicator on the premises in a stationary location within voice communication distance of a possible fall location, the two-way voice communicator separate from the wearable device and capable of being enabled by a remote responder for two-way independent voice communication between a remote responder and a person wearing the wearable device in the possible fall location.

7. The system of claim 6, the wearable device comprises a bracelet.

8. The system of claim 6, the two-way voice communicator is secured as a fixture on the premises.

9. The system of claim 6, the two-way voice communicator comprises a signal receiver for receiving the wireless alert signal from the wearable device and a signal transmitter for transmitting a fall notification signal to the base transmitter, and the base transmitter is capable of responding to the fall notification signal by transmitting a responder request to a remote responder.

10. A method for communicating a fall event on a premises to a remote responder off the premises, and for enabling a remote responder to communicate with a person who has suffered the fall event on the premises, characterized by:
providing a device comprising a fall sensor responsive to a physical effect of a fall by a person wearing the device to generate a sensed-fall signal, and further comprising a wireless transmitter capable of sending a wireless alert signal in response to the sensed-fall signal from the fall sensor without requiring participation of a person wearing the device;
providing a base transmitter on the premises, the base transmitter capable of being enabled in response to the wireless alert signal to transmit a responder request to a remote responder;
providing a two-way voice communicator on the premises in a location within voice communication distance of a possible fall location, the two-way voice communicator being stationary and separate from the wearable device and capable of being enabled by a remote responder for independent two-way voice communication between a remote responder and a person wearing the wearable device in the possible fall location.

11. The method of claim 10, further comprising causing a person on the premises to wear the device.

12. On a premises where a person may fall, a response system characterized by:
wearable means for responding to a physical effect of a fall by a person wearing the wearable means, and for sending a wireless alert signal in response to the physical effect without requiring participation of a person wearing the wearable means;
base transmitter means located on the premises for responding to the wireless alert signal by transmitting a responder request to a remote responder;
two-way voice communicator means on the premises in a stationary location within voice communication distance of a possible fall location for independent two-way voice communication between a remote responder and a person wearing the wearable device in the possible fall location, the two-way voice communicator means separate from the wearable device.
